(19) United States
(12) Patent Application Publication
(10) Pub. No.: US 2017/0316455 A1
(43) Pub. Date: Nov. 2, 2017

(54) System and Method for Counting Advertisement Impressions

(71) Applicant: Oracle America, Inc., Redwood Shores, CA (US)

(72) Inventors: Daniel Fichter, New York, NY (US); James Hartzell, New York, NY (US); Michael Garrett Seiler, Scarsdale, NY (US); Christopher Tsoufakis, Salt Lake City, UT (US)

(73) Assignee: Oracle America, Inc., Redwood Shores, CA (US)

(21) Appl. No.: 13/957,215

(22) Filed: Aug. 1, 2013

Related U.S. Application Data
(60) Provisional application No. 61/678,244, filed on Aug. 1, 2012.

(51) Int. Cl. G06Q 30/02

(52) U.S. Cl. CPC G06Q 30/0246

(57) ABSTRACT

A system and methods for providing accurate counting of advertisement impressions is described. The system and methods include bloom filter technology or other space-efficient probabilistic data structure algorithms to efficiently determine whether any particular advertisement impression across an enormous set of possibilities has been viewed previously or not, without having to search through every instance of rendering of any particular advertisement impression. The present system and methods include arrays of multiple bloom filters and manipulate them to correct for false positives when conditions create the risk of false positives that may have occurred during data capture on a browser. In addition, the system and methods generate unique qualification identifiers for advertising served, which is evaluated by the bloom filters before a count is incremented.

### CROSS REFERENCE TO RELATED APPLICATIONS

The present application claims the benefit of priority under 35 U.S.C. §119(e) of U.S. Provisional Application No. 61/678,244 entitled “System and Method for Counting Ad Impressions,” filed on Aug. 01, 2012, by Daniel Fichter, James Hartzell, Michael Garrett Seiler, and Chris Tsoufakis. The entire contents of the provisional application are incorporated by reference herein.

### BACKGROUND

This invention relates to a system and methods for counting advertisement impressions, in particular with an analytics server including bloom filter technology for efficient and accurate counting of advertisement impressions and generating unique qualifying data for each instance that an advertisement is served.

Online publication has replaced traditional ways of distributing content. Publishers of online content receive revenue for the content they produce by either invoking a pay-per-view payment scheme or subscription scheme. Yet, there are many publishers who offer free content to the public, yet only with relying on advertising. In this scenario, placement of advertising on a website involves determining appropriate and fair pricing for the spaces where the advertising will be placed. Advertising spaces are typically sold on either a pay-per-impression viewing or on a pay-per-click basis. In a pay-per-impression advertising scenario, a charge is imposed each time the web page containing a particular advertisement is viewed by consumers. This is facilitated by maintaining copious records that reflect every instance that a particular advertisement is downloaded by a user for viewing. In this scenario, the advertiser is charged for the volume of downloads that have occurred in relation to the particular advertisement served by the advertiser. It is estimated that advertisements are served to consumers online roughly 50 billion times a day.

Therefore, it is advantageous when counting frequent events such as the serving of advertising to consumers online to be able to provide an accurate count, and correct for lost data, avoid double-counting, and to be able to establish that a number of data elements are associated with a single instance of an advertisement being served. These attributes make counts more accurate than environmental factors would normally allow in more conventional counting schemes. Specifically, in the advertising environment, there is a dire need to provide an accurate count of: a) the number of times any particular advertisement renders across a universe of web pages (i.e., number of loads); b) the number of times a particular user has viewed a particular advertisement, regardless of the context in which it is viewed (i.e., frequency); and c) the number of unique users who have viewed any particular advertisement without regard to how often they see it (i.e., unique reach).

### SUMMARY

The present invention relates to a system and methods configured for counting frequent events, for example serving of advertising to consumers or clients online, to provide an accurate count that advantageously corrects for lost data, avoids double-counting of an instance of advertising resulting from communication or other errors, and establishes a count based on generating a unique qualification identifier including a number of data elements, attributes, or characteristics associated with a single instance of advertising being served. These attributes make counts more accurate than environmental factors would normally permit in more conventional counting schemes. Specifically, in the advertising environment, the present invention advantageously addresses a dire need to provide an accurate count of: a) the number of times any particular advertisement renders across a universe of web pages (i.e., number of loads); b) the number of times a particular user has viewed a particular advertisement, regardless of the context in which it is viewed (i.e., frequency); and c) the number of unique users who have viewed any particular advertisement without regard to how often they see it (i.e., unique reach).

The system and method use bloom filter technology to perform these tasks. Yet, there may be some risks involved with using “bloom Filters” for these tasks. In some instances, there is a risk that the filter will “fill up,” resulting in incorrect readings from the filter. In one aspect of the present invention, a method involves maintaining the reliability of a bloom filter in this application, which is described here. A bloom filter (or other space-efficient probabilistic data structure) algorithm is used to enable a computer to efficiently determine across an enormous set of possibilities (e.g. 10**20) whether it has seen a given case (e.g., advertisement) previously, or not, without having to search each case (e.g., advertisement) and compare it to all other cases. The present invention uses bloom filter technology in novel ways and in a number of ways including: 1) by manipulating arrays of (multiple) bloom filters to correct for false positives when conditions create the risk of false positives; 2) by using filters as part of a plan to correct for errors that may have occurred during data capture on a browser. In this embodiment, multiple indications of an event (advertisement rendering) are created intentionally so that if one indication fails to be communicated, the other indications may be used. The bloom filter in this case corrects for any possible double counting even though several indications of the event may be present in the data representing the event being counted. This is advantageous because it relieves the software entity creating the input to the filter from having to be perfectly reliable; and 3) how bloom filters are used to count reach, opportunity to see, and frequency in a defined universe of served advertisements.

In some implementations, the methods of the present invention are configured for determining a count for advertising impressions, and comprise: 1) requesting an advertisement from an advertisement server, by one or more processors, from a web page; 2) receiving the advertisement and related code from the advertisement server, by the one or more processors; 3) facilitating rendering of the advertisement on a browser, by the one or more processors, wherein the code establishes communication with an analytics server; 4) with every instance of rendering of the advertisement, generating unique qualifying data including at least a timestamp and a random number and informing, by the one or more processors, a bloom filter from an array of bloom filters in the analytics server; 5) monitoring a threshold characteristic of the bloom filter and replacing the bloom filter with another from the array when the threshold size is reached to prevent an inaccurate count of advertisement renderings; and 6) maintaining a count for the advertisement and incrementing the count upon considering the qualifying data for the advertisement.

In some implementations, the system of the present invention includes a processor, and a memory storing instructions that, when executed, cause the system to: 1) request an advertisement from an advertisement server, from a web page; 2) receive the advertisement and related code from the advertisement server; 3) facilitate rendering of the advertisement on a browser, wherein the code establishes communication with an analytics server; 4) with every instance of rendering of the advertisement, inform a bloom filter from an array of bloom filters in the analytics server; and 4) monitor a threshold characteristic of the bloom filter and replacing the bloom filter with another from the array when the threshold size is reached to prevent an inaccurate count of advertisement renderings.

The system and methods of the present invention may be implemented on one or more computer program products and provide a user interface for display to a user, wherein the user interface indicates an accurate count with respect to the advertisement and indicates unique attributes relating to advertisement renderings.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram of an embodiment of a system including an analytics server and a collection plug-in (or apple etc.), which implement the method of the present disclosure to track and provide an accurate count of advertisement impressions.

FIG. 2A is a block diagram illustrating example hardware components of the client device on which the collection plug-in is resident.

FIG. 2B is a block diagram illustrating example software components of the collection plug-in, applet, or the like.

FIG. 3A is a block diagram illustrating example hardware components of the analytics server.

FIG. 3B is a block diagram illustrating example software components of the analytics server and bloom filter (or array of bloom filters).

FIG. 4 is a flow chart illustrating an example general method for efficient and accurate counting of advertisement impressions by using bloom filters and creating or using a new bloom filter when a threshold size is reached.

FIG. 5 is a flow chart illustrating an example general method for efficient and accurate counting of advertisement impressions by associating unique characteristics with advertisements and eliminating duplicate instances.

FIGS. 6 is a graphical representation of an example user interface.

FIG. 7A is a graphical representation illustrating an example scenario with respect to an advertisement that is viewed for the very first time by a user. In this particular instance, there is no display of an advertisement count.

FIG. 7B is a graphical representation illustrating another example scenario where a second user views the same advertisement referenced in FIG. 7A. In this example, as the first user has already viewed that advertisement, the graphical user interface provides a message (e.g., count).

FIG. 7C is a graphical representation illustrating yet another example scenario in which an nth (e.g., 10^{th}) user views the same advertisement referenced in FIG. 7A-B. In this example, as N−1 (i.e. 9) users have already viewed that advertisement, the graphical user interface provides a message (e.g., count).

FIG. 7D is a graphical representation illustrating an example scenario with first -nth users watching the same advertisement 702 again. This example illustrates that the system provides the same advertisement count in instances where user view an advertisement that has already been viewed before.

FIG. 8 is diagram illustrating an example data storage configuration with various examples of criteria for data collected and conveyed to the analytics server.

### DETAILED DESCRIPTION

The present invention relates to a system and methods configured for counting frequent events, for example, serving of advertising to consumers or clients online, to provide an accurate count that advantageously corrects for lost data, avoids double-counting of an instance of advertising, and establishes an accurate count based on generating unique qualification identifiers for advertisements including a number of data elements associated with a single instance of advertising being served. These attributes make counts more accurate than environmental factors would normally permit in more conventional counting schemes. Specifically, in the advertising environment, the present invention advantageously addresses a dire need to provide an accurate count of: a) the number of times any particular advertisement renders across a universe of web pages (i.e., number of loads); b) the number of times a particular user has viewed a particular advertisement, regardless of the context in which it is viewed (i.e., frequency); and c) the number of unique users who have viewed any particular advertisement without regard to how often they see it (i.e., unique reach).

The system and methods described here use bloom filter technology to perform these tasks. Yet, there may be some risks involved with using “bloom filters” for these tasks. In some instances, there is a risk that the filter will “fill up,” resulting in incorrect readings from the filter. In one aspect of the present invention, a method involves maintaining the reliability of a bloom filter in this application, which is described here. A bloom filter (or other space-efficient probabilistic data structure) algorithm is used to enable a computer to efficiently determine across an enormous set of possibilities (e.g. 10**20) whether it has seen a given case (e.g., advertisement) previously, or not, without having to search each case (e.g., advertisement) and compare it to all other cases. The present invention uses bloom filter technology in novel ways and in a number of ways including: 1) by manipulating arrays of (multiple) bloom filters to correct for false positives when conditions create the risk of false positives; 2) by using filters in some implementations to correct for errors that may have occurred during data capture on a browser. In this embodiment, multiple indications of an event (advertisement rendering) are created intentionally so that if one indication fails to be communicated, the other indications may be used. The bloom filter in this case corrects for any possible double counting even though several indications of the event may be present in the data representing the event being counted. This is advantageous because it relieves the software entity creating the input to the filter from ensuring that data is perfectly reliable; and 3) and using bloom filters to assess considerations, for example, reach to consumers, opportunity to view, and frequency in a defined universe of served advertisements.

In the following description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments below with reference to user interfaces and particular hardware. However, the present technology applies to any type of computing device that can receive data and commands, and any devices providing services.

Reference in the specification to “one embodiment or implementation,” “an embodiment or implementation,” or “some embodiments or implementation” means simply that one or more particular features, structures, or characteristics described in connection with the one or more embodiments or implementations is included in at least one or more embodiments or implementations that are described. The appearances of the phrase “in one embodiment or one implementation” in various places in the specification are not necessarily all referring to the same embodiment.

Some portions of the detailed descriptions that follow are presented in terms of method algorithms and symbolic representations of operations on data bits within a computer memory of either one or more computing devices typically used in. These algorithmic descriptions and representations are the means used by those skilled in the data processing and arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” “transmitting,” or “displaying” or the like, refer to the actions and processes of a computer device or system or similar electronic computing device that manipulates and transforms data represented as physical (electronic) quantities within the computer device or system's registers and memories into other data similarly represented as physical quantities within the computer system memories or registers or other such information storage, transmission, or display devices.

The present technology also relates to system architecture for performing the operations described here. This system architecture may be specially constructed for the required purposes or methods stated here, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology may take the form of an entirely hardware embodiment, an entirely software embodiment, or an embodiment including both hardware and software components. In some embodiments, this technology is implemented in software, which includes but is not limited to firmware, resident software, microcode, etc.

Furthermore, at least portions of this technology may take the form of one or more computer program products accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device. The components used in systems and networks may use a data processing system suitable for storing and/or executing program code including at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) may be coupled to the system architecture either directly or through intervening I/O controllers.

Communication units including network adapters may also be coupled to the systems to enable them to couple to other data processing systems or storage devices, through either intervening private or public networks. Modems, cable modems, and Ethernet cards are just a few examples of the currently available types of network adapters.

Finally, the algorithms and operations presented in this application are not inherently related to any particular computer or other apparatus. Various general-purpose systems may be used or modified with programs in accordance with the teachings here, or it may prove convenient to construct more specialized apparatus to perform the required method steps. The required structure for a variety of these systems is outlined in the description below. In addition, the present technology is not described with reference to any particular programming language. It should be understood that a variety of programming languages may be used to implement the technology as described here.

The present technology is now described more fully with reference to the accompanying figures, in which several embodiments of the technology are shown. The present technology may be embodied in many different forms and should not be construed as limited to the embodiments set forth herein. Rather, these embodiments are provided so that this disclosure will be thorough and complete and will fully convey the invention to those skilled in the art.

One skilled in the art will recognize that methods, apparatus, systems, data structures, and computer readable media implement the features, functionalities, or modes of usage described herein. For instance, an apparatus embodiment can perform the corresponding steps or acts of a method embodiment.

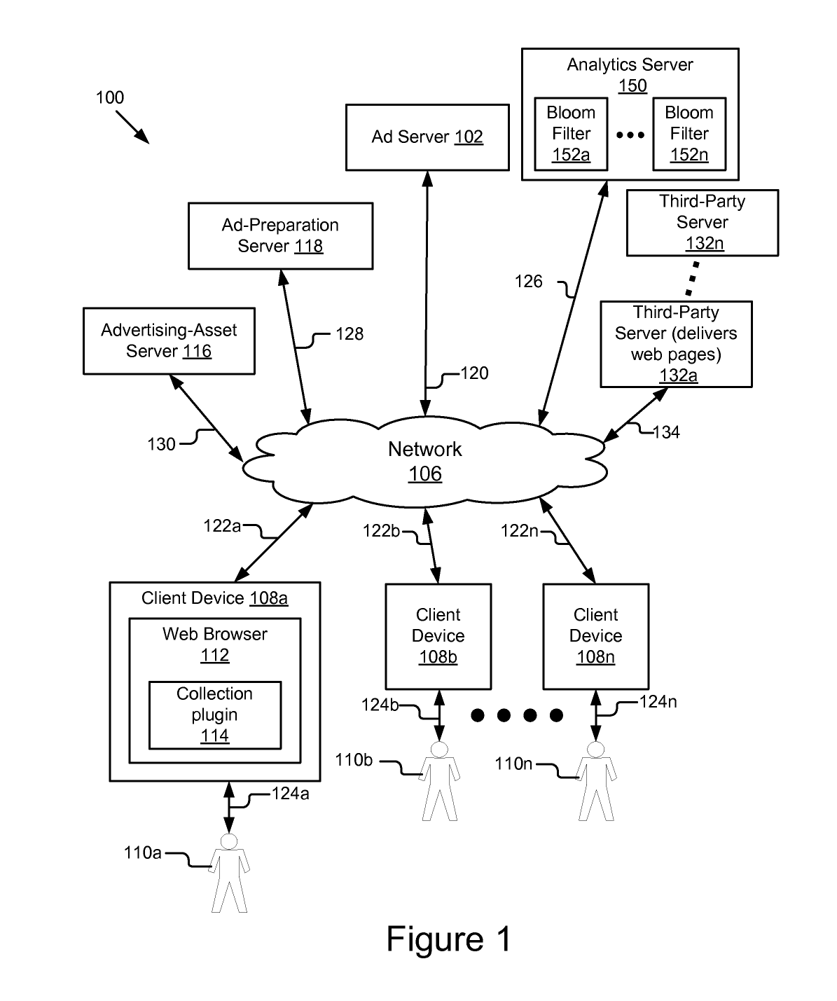

In one embodiment shown in FIG. 1, the invention includes bloom filter technology implemented in an analytics server 150 and operable with at least partly a collection plug-in 114 resident in a client device 108a (or 108b-108n). FIG. 1 illustrates a block diagram of an example advertising system architecture 100 including a system for providing an accurate count of advertisement impressions in accordance with the present invention. The advertising system architecture 100 is configured to advantageously provide an accurate count of advertisement impressions that are viewed by consumers or clients (e.g., consumers or clients 110a . . . 110n) with addressing a data loss or instance of multiple viewings. For many of the examples described in the specification below, it should be recognized that an online advertisement (or “ad”) may be any text, picture, or video (with dynamic images), the purpose of which is advertising communication including any flash asset, any image of Internet Advertising Board (IAB) or industry standard width and height that is clickable including any recursion into iframes from the original page. It should be recognized that an advertisement may also include one or more hyperlinks, so that when a particular advertisement is rendered by a client (or consumer) device, it is possible to select these hyperlinks in order to be redirected to further content provided by an advertiser. A particular advertisement may be encoded by an advertiser as a HyperText Mark-up Language (HTML) file.

The illustrated “ad” system 100 includes an “Advertising-Asset” server 116 (hereafter “advertising-asset” server), an “Ad-Preparation” (hereafter “ad-preparation” server) server 118, an “Ad Server” (hereafter “ad” server) 102, a network 106, one or more “Third-Party” (hereafter “third-party” servers) servers 132a . . . 132n (individually and collectively herein referred to as 132), and one or more client devices 108a-108n that are accessed by users 110a-110n. In the illustrated embodiment, these entities are communicatively coupled via the network 106. Although only three client devices 108a-n are illustrated, it should be recognized that any number of client devices 108n are available to any number of users 110n. Furthermore, while only one network 106 is coupled to the advertising-asset server 116, the ad-preparation server 118, the ad server 102, the analytics server 150 with a bloom filter 152, the third-party servers 132a-n, and the one or more client devices 108a-108n, in practice any number of networks 106 can be connected to the entities.

In one embodiment, the advertising-asset server 116, the ad-preparation server 118, the ad server 102, the analytics server 150, and the third-party server 132a-n are hardware servers including a processor, memory, and network communication capabilities. Although only two third-party servers 132a and 132n are shown, the system 100 may include any number of third-party servers 132.

The network 106 is a conventional type, wired or wireless, and may have any number of configurations such as a star configuration, token ring configuration or other configurations. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or includes portions of a telecommunications network for sending data in a variety of different communication protocols. In yet another embodiment, the network 106 includes Bluetooth communication networks or a cellular communications network for sending and receiving data such as via short messaging service (SMS), multimedia messaging service (MMS), hypertext transfer protocol (HTTP), direct data connection, WAP, email, etc.

The client (alternatively referred to as a consumer, user, or viewer) device 108a is representative of client devices 108a-108n and is a conventional type of computing device, for example, a personal computer, a hardware server, a laptop computer, a tablet computer, or smart phone. The client devices 108a-108n are illustrated, as coupled to the network 106, by signal lines 122a-122n, respectively. In one embodiment, the client device 108 (e.g., 108a) is coupled to receive online advertisements from the ad server 102 and other content from publishing sites or third-party servers 132. The client device 108 (e.g., 108a) includes a web browser 112 for presenting online content and advertisements to the user (e.g., 110a). The web browser 112 presents advertisements and other content, and receives input from the user 110a (e.g. from 110a-110n) as represented by signal line 124 (e.g., 124a). The web browser 112 is configured to provide access to a hosted web page (for example, as delivered by any of the third-party servers 132a-n). The web page may comprise a main area in which content is displayed and an advertisement. In some instances, the advertisement may be contained within an iframe.

The web browser 112 and collection plug-in (applet or the like) 114 are operable on the client device 108 (e.g., 108a). The collection plug-in 114 may be configured to include a Flash Object, an ActionScript, or a JavaScript and associate any of these with a particular advertisement to initiate a process (e.g., a JavaScript), to signal the analytics server 150 with bloom filter 152, or in some instances a network resident (external to the computer running the browser) database with the information that a particular advertisement rendered in a particular webpage or in a particular browser, is being viewed by a consumer. The system and methods of the present technology use this characteristic to keep track of each viewing of any particular advertisement.

The advertising-asset server 116 is a computer program operating on a hardware system for storing and providing advertisements or assets to other systems that will ultimately deliver or serve the advertisements to a particular end user. The advertising-asset server 116 is coupled to the network 106 by signal line 130 to illustrate receiving advertisements or assets from advertisers. In one embodiment, the advertising-asset server 116 is also configured to store the advertisements or assets that will be delivered or served to the client devices 108(a-n) for viewing. For example, the asset may include an advertisement copy, advertisement content, JavaScript or Flash that when executed by the client device 108(a-n) in the web browser 112 presents the advertisement to the user 110 as designed by and intended by the advertiser. The advertisers interact or communicate with the advertising-asset server 116 to upload and store advertisements on the advertising-asset server 116. These advertisements are then available for delivery and serving to the ad-preparation server 118 or the ad server 102, which in turn process the advertisements and deliver them to the client device 108(a-n).

The ad-preparation server 118 is a computer program operating on a hardware system for preparing advertisements for ultimate delivery to the client devices 108(a-n). In one embodiment, the ad-preparation server 118 may be configured to retrieve advertisements from the advertising-asset server 116 and modify them (e.g., by adding a script). The modified advertisements are then delivered by the ad-preparation server 118 to the ad server 102 for combination with content and delivery to the client device 108(a-n). The ad-preparation server 118 is coupled to the network 106 by signal line 128 for communication with the advertising-asset server 116 and the ad server 102.

The ad server 102 is a computer program operating on a hardware system for placing advertisements on websites. For example, the ad server 102 may be a web server that receives advertisements from the ad-preparation server 118 or the advertising-asset server 116 and delivers them to website visitors. The ad server 102 is coupled to the network 106 by signal line 120 for receiving advertisements from the ad-preparation server 118 or the advertising-asset server 116 and for delivering and serving the advertisements to third-party servers 132(a-n), sites or domains (not shown).

The analytics server 150 includes a computer program operating on a hardware system configured to receive data from the collection plugin 114 on whether particular advertisements are being viewed by a consumer. The analytics server 150 with the bloom filter 152 is coupled by signal line 126 to the network 106 for communication with client devices 108a-108n and ad server 102.

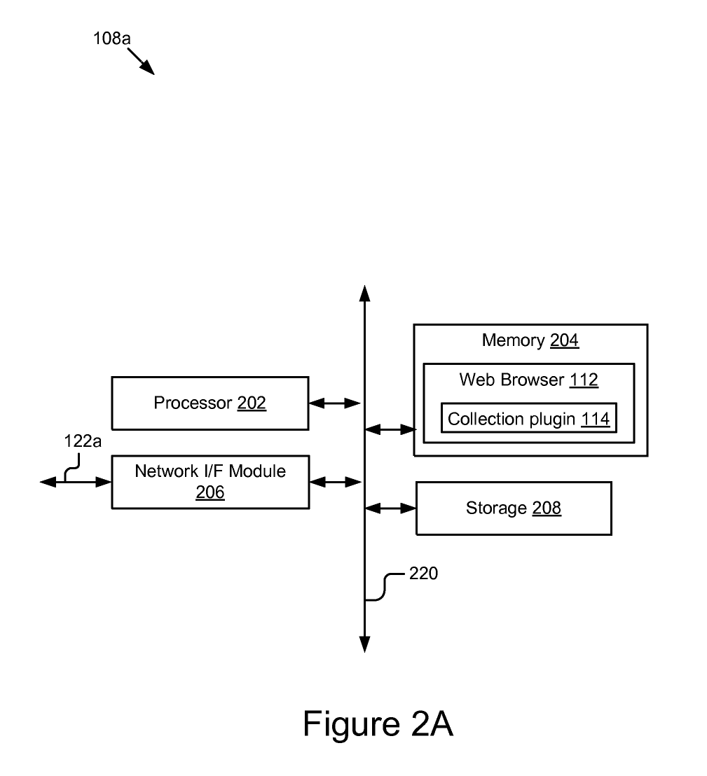

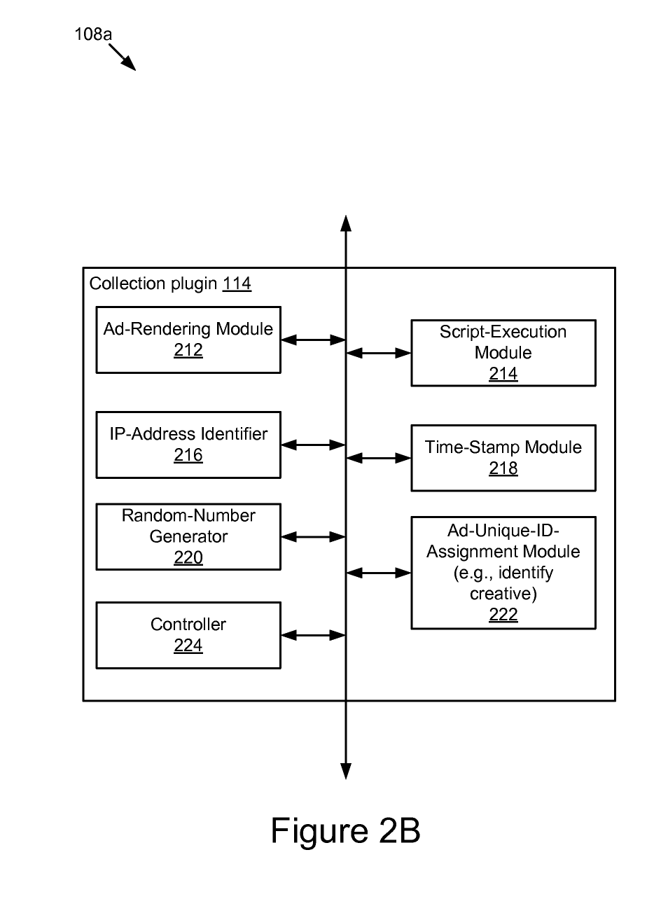

FIG. 2A is a block diagram of one embodiment of the client device 108a. In this embodiment, the client device 108a (or any through 108n) comprises: one or more processors 202, although only one processor 202 is shown for illustration purposes, memory 204, a bus 220, a network interface (I/F) module 206, and storage 208

The one or more processors 202 comprise an arithmetic logic unit, a microprocessor, a general-purpose controller or some other processor array to perform computations and provide electronic display signals that may be viewed by the consumer or client. The one or more processors 202 are coupled to the bus 220 for communication with the other components. The one or more processors 202 process data signals and may comprise various computing architectures including a complex instruction set computer (CISC) architecture, a reduced instruction set computer (RISC) architecture, or an architecture implementing a combination of instruction sets. Other processors, operating systems, sensors, displays and physical configurations are possible.

The memory 204 stores instructions and/or data that may be executed by the one or more processors 202. The memory 204 is coupled to the bus 220 for communication with the other components. The instructions and/or data may comprise code for performing any and/or all of the techniques described herein. The memory 204 may be a dynamic random access memory (DRAM) device, a static random access memory (SRAM) device, flash memory or some other memory device. In some embodiments, the memory 204 stores the web browser 112, which includes the collection plugin 114.

The network interface (I/F) module 206 is coupled to network 106 by signal line 122a (or 122b through 122n) and coupled to the bus 220. The network interface module 206 includes ports for wired connectivity such as but not limited to USB, SD, or CAT-5, etc. The network interface module 206 links the one or more processors 202 to the network 106 that may in turn be coupled to other processing systems. The network interface module 206 provides other connections to the network 106 using standard network protocols such as TCP/IP, HTTP, HTTPS and SMTP. In other embodiments, the network interface module 206 includes a transceiver for sending and receiving signals using Wi-Fi, Bluetooth® or cellular communications for wireless communication. The network interface (I/F) module 206 provides a communication path for the components of the client device 108a (or 108b through 108n) to the network 106 and other systems.

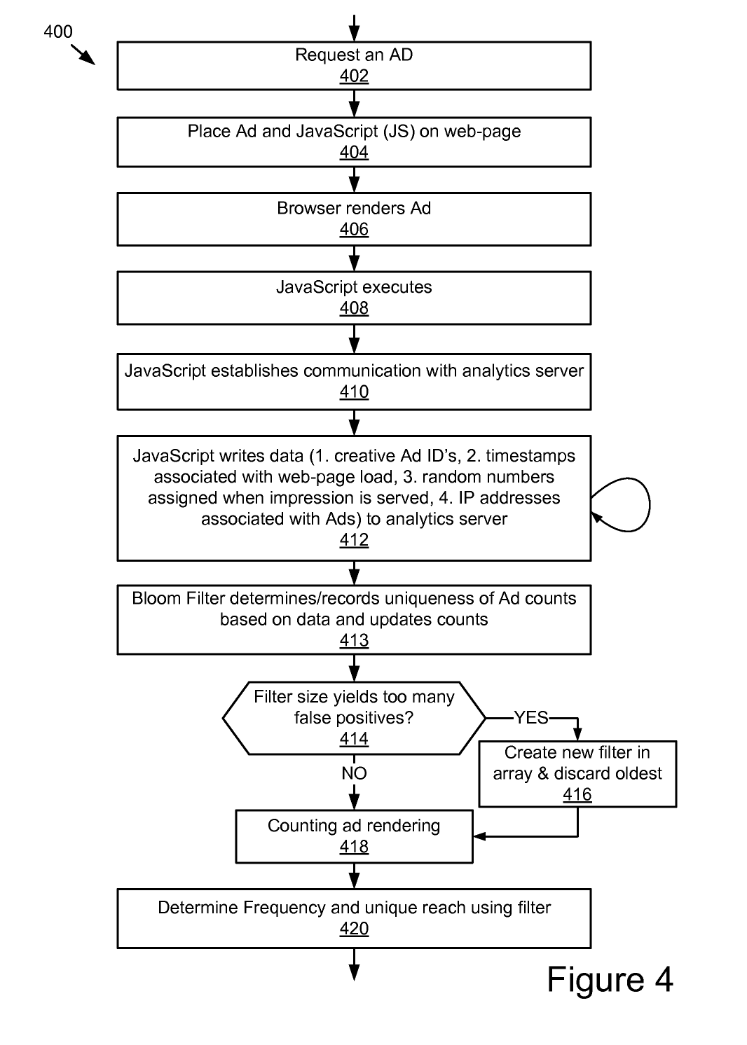

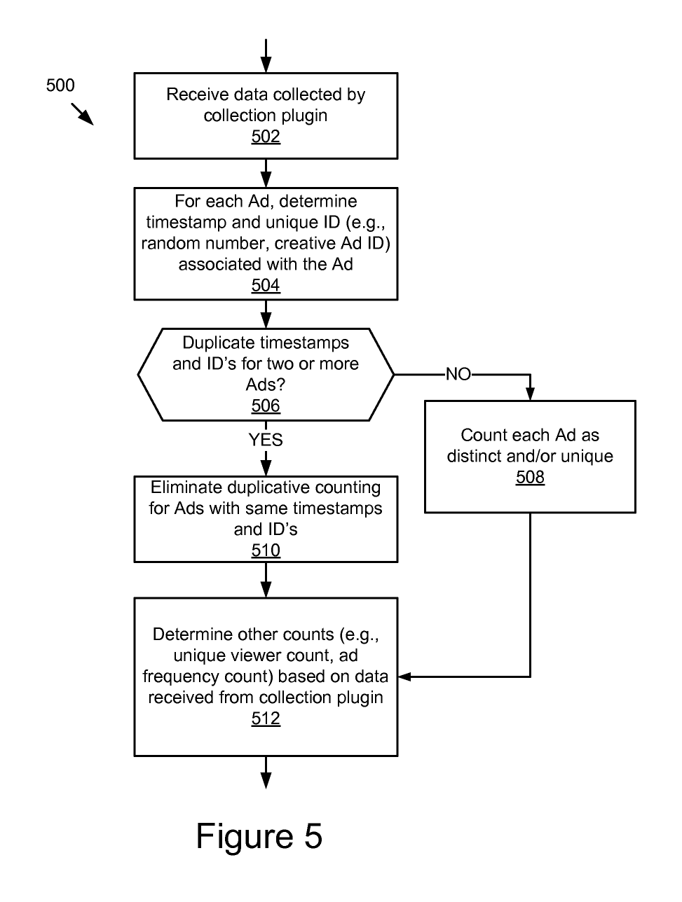

Referring now to FIG. 2B, the collection plugin 114 further comprises an Ad-Rendering Module 212, a Script-Execution Module 214, an IP-Address Identifier 216, a Time-Stamp module 218, a Random-Number Generator 220, an Ad-Unique-ID-Assignment Module (e.g., identity creative) 222, and a Controller 224. Each of these modules may be software programs or routines with instructions that cause the processor 202 (FIG. 2A) in conjunction with the other components to perform the functionalities described in FIGS. 4 and 5. The Ad-Rendering Module 212 renders and/or loads advertisements across a plurality of web pages. The Script-Execution Module 214 executes scripts (e.g., JavaScripts) that are placed on web pages and establishes communication with the analytics server 150 for writing data that is generated on executing the scripts. The IP-Address Identifier 216 uniquely identifies devices from which users viewed advertisements on web pages. The Time-Stamp module 218 records time at which different advertisements are rendered and/or loaded on web pages. The Random-Number Generator 220 generates random numbers to be associated with advertisements when the ad impressions are served at the client side. The Ad-Unique-ID-Assignment Module 222 assigns unique ID's (e.g., random numbers, creative Ad ID's) to advertisements and the Controller 224 send and/or receives data to and/or from the analytics server 150.

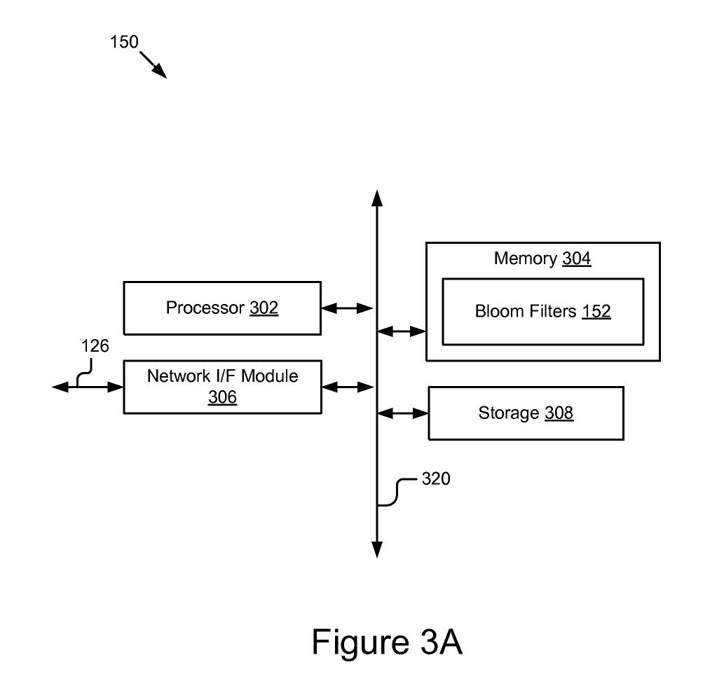

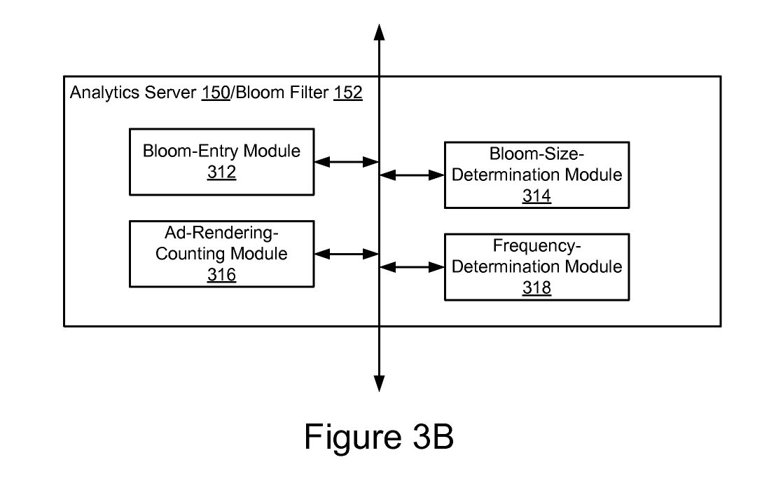

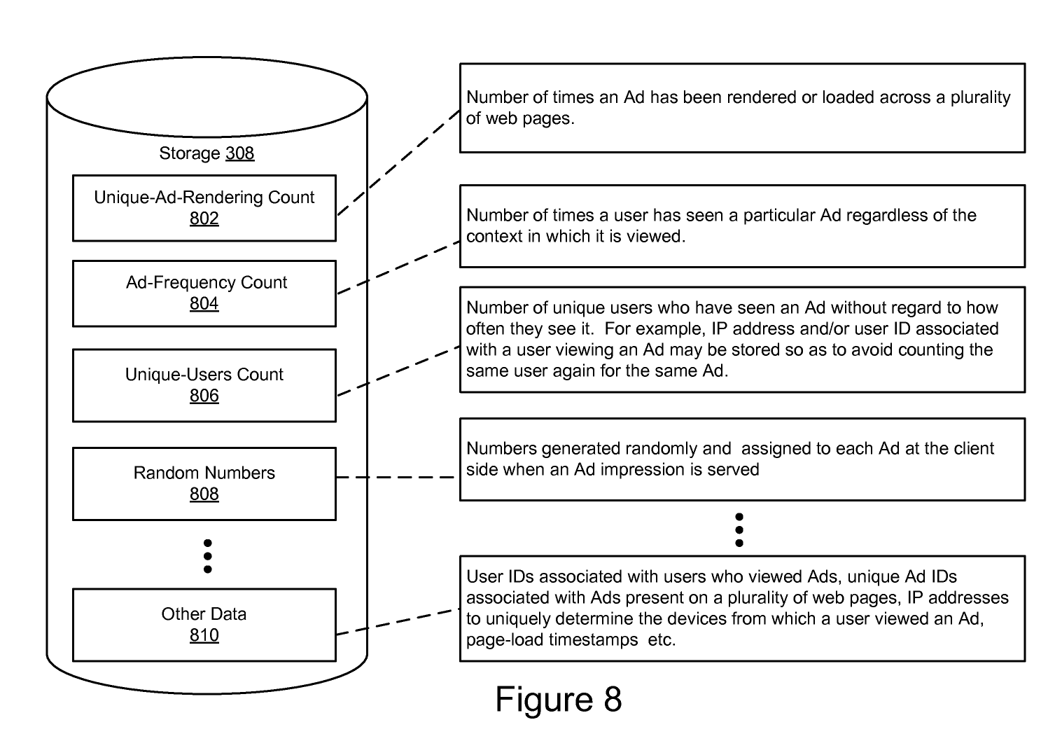

Referring now to FIG. 3A, the hardware components of the Analytics Server 150 are illustrated. The analytics server 150 includes a Processor 302, a Memory 304 including an array of bloom filters 152, a Network I/F Module 306 and Storage 308 also illustrated in FIG. 8. The Network I/F Module 306 connects the Analytics Server 150 to the Network 106.

The one or more processors 302 comprise an arithmetic logic unit, a microprocessor, a general-purpose controller or some other processor array to perform computations and provide electronic display signals that may be viewed by the consumer or client. The one or more processors 302 are coupled to the bus 320 for communication with the other components. The one or more processors 302 process data signals and may comprise various computing architectures including a complex instruction set computer (CISC) architecture, a reduced instruction set computer (RISC) architecture, or an architecture implementing a combination of instruction sets. Other processors, operating systems, sensors, displays and physical configurations are possible.

The memory 304 stores instructions and/or data that may be executed by the one or more processors 302. The memory 304 is coupled to the bus 320 for communication with the other components. The instructions and/or data may comprise code for performing any and/or all of the techniques described herein. The memory 304 may be a dynamic random access memory (DRAM) device, a static random access memory (SRAM) device, flash memory or some other memory device. In some embodiments, the memory 304 stores an array of bloom filters 152.

The network interface (I/F) module 306 is coupled to the network 106 by signal line 126 and coupled to the bus 320. The network interface module 306 includes ports for wired connectivity such as but not limited to USB, SD, or CAT-5, etc. The network interface module 306 links the one or more processors 302 to the network 106 that may in turn be coupled to other processing systems. The network interface module 306 provides other connections to the network 106 using standard network protocols such as TCP/IP, HTTP, HTTPS and SMTP. In other embodiments, the network interface module 306 includes a transceiver for sending and receiving signals using Wi-Fi, Bluetooth® or cellular communications for wireless communication. The network interface (I/F) module 306 provides a communication path for the components of the client device 108a (or 108b through 108n) to the network 106 and other systems.

FIG. 3B illustrates the software components of the Analytics Server 150 and the Bloom Filter 152, including a Bloom-Entry Module 312, a Bloom-Size-Determination Module 314, an Ad-Rendering-Counting Module 316, and a Frequency-Determination Module 318. Each of these modules may be software programs or routines with instructions that cause the processor 302 (FIG. 3A) in conjunction with the other components to perform the functionalities described in FIGS. 4 and 5. The Bloom-Entry Module 312 receives data received from the client devices 108a through 108n. The Bloom-Size-Determination Module 314 determines when the bloom filter 152 yields too many false positives, at which point a new bloom filter 152 is used. The Ad-Rendering-Counting Module 316 tracks the count from the data received from the client devices 108a-108n and the Frequency-Determination Module 318 may record the number of times that a particular advertisement has been served, to a particular user or otherwise.

Referring now to FIG. 4, the method of the present invention is described below. The method uses bloom filters for efficient and accurate counting of ad impressions. The method indicated generally by reference numeral 400 includes one or more operations illustrated by block 402 where the ad server 102 (FIG. 1) is called by a web page with a request to place an advertisement, and code, for example, a JavaScript tag in that web page. The method 400 proceeds to the next block 404, including one or more operations, by which the ad server 102 places a particular advertisement and JavaScript on the web page.

The method 400 proceeds to the next block 406, including one or more operations, by which the browser 112 renders the advertisement. The method 400 proceeds to the next block 408, including one or more operations, by which the JavaScript begins to execute operations. The method 400 proceeds to the next block 410, including one or more operations, by which the JavaScript establishes communication with an analytics server 150. From there, the method 400 proceeds to the next block 412, by which at various times and for various reasons the JavaScript writes data on that instance of rendering of the advertisement to the analytic server 150. For example, the data being written and/or provided to the analytics server 150 may include, without limitation, 1. Creative Ad ID's, 2. Timestamps associated with web-page load, 3. Random numbers assigned when impression is served, and 4. IP addresses associated with Ads.

The method 400 proceeds to the next block 413 including one or more operations, by which the analytic server 150, for each occurrence of data being written, creates an entry in a bloom filter, which refers to that advertisement, in that instance in which the advertisement is being rendered. The data written to the analytics server 150 includes several variables or attributes, many of which may be used later to compute several aspects of uniqueness i.e., a unique user agent, unique rendering of that advertisement, unique (IP address+user agent), etc. In other implementations, updating of the bloom filter may be performed asynchronously as also illustrated by block 413. The method 400 includes one or more operations as illustrated by block 413, by which the bloom filter 152 determines and records unique characteristics of advertisements based on the qualifying data received from the client devices 108a-108n and updates their respective counts.

The method 400 proceeds to the next decision block 414, which may include one or more operations by which, in accordance with a routine process, a program operating on the analytic server 150 checks to see if the bloom filter has grown to a size that may cause it to yield too many false positives for the application. If that condition has occurred and is sensed as such, the method 400 proceeds to the next block 416, including one or more operations by which the same program creates a new bloom filter in an array of bloom filters (FIG. 1), and sheds the oldest filter from the array. In this way, the system prevents a filter 152 from reaching a state in which it delivers compromised results, thereby keeping it functioning in a reliable manner. This operation is significant to the system and methods of the present invention, wherein the array of bloom filters “sheds” a filter, and creates a new one. In the instance, where the method 400 creates a new bloom filter, it proceeds to the next block 418 including one or more operations for (at a later time) that initiate in the analytic server 150 a process for counting or tracking the number of times any particular advertisement has been rendered (or loaded) by a browser 112. The bloom filter 152 advantageously shows a single instance of an advertisement rendering even if several duplicate indications of rendering (for example, because of errors in communication) of that advertisement exist in the data received from the client device 108a-108n. Because all instances of double counting are eliminated, multiple false indications of the same advertisement rendering advantageously count as one. In the instance that block 414 determines that the bloom filter 152 size does not yield too many false positives, the method 400 proceeds directly to block 418, at which the counting of the advertisement rendering occurs.

In some implementations, at a later time, it may be desirable to determine whether an instance of a specific user viewing of a specific or particular advertisement was unique, or whether a particular user viewed a particular advertisement multiple times (user identification). The method 400 illustrates these aspects by block 420, which may include one or more operations to illustrate that the bloom filter 152 may match user identification with advertisement identification to determine the number of times a particular user viewed any particular advertisement identification.

FIG. 5 illustrates an example method for generating an accurate count of advertisement impressions. The example method is indicated by reference numeral 500 and begins with block 502 including one or more operations for receiving data collected by the collection plug-in. In some implementations, the data is received at the analytics server 150 (FIG. 1) from the collection plug-in 114 (FIG. 1), which is resident in the client devices 108a, 108b, through 108n. To ensure correct counting of advertisements being served and to compensate for environmental factors, the method 500 generates a unique key for each advertisement impression when it is served or downloaded on a client device 108a, including an IP address (associated with the client device), a page-load timestamp, a creative, and a random number. For each advertisement, the method generates a random number at the time the impression is served on the client device 108a and includes that random number in the unique key. These operations are illustrated by block 504. By this method, two instances of the same advertisement on the same web page are treated separately even in the instance that they are served in the same millisecond. Advantageously, the method allows for counting unique characteristics of an advertisement served to an IP address, by assigning a time stamp and a unique number for each creative or advertisement that is served. As one example, if the same advertisement is served twice to the same person (e.g., consumer, user, or client) in the same screen, and even in the same placement location, a count of two would be accorded as the time stamps for each instance that the advertisement was served is different. Therefore, the method 500 considers if there are duplicate timestamps or unique IDs for multiple advertisements before incrementing a count. This determination is illustrated by block 506. In the event there are no duplicate timestamps, that is each is different, or the unique IDs are different, the method 500 counts each advertisement as distinct and/or unique. These operations (one or more) are illustrated by block 508. In the event there are duplicate timestamps or unique IDs (with the same data including random numbers), the data reflecting the duplicates are not counted or taken into consideration. These operations (one or more) are illustrated by block 510. Each instance of an advertisement being served is inserted into the bloom filter 152 with its qualifying data (including the unique ID generated for each advertisement with time stamp, random number etc.). The bloom filter 152 provides two significant benefits. First, it does not record or count the same instance of the same advertisement twice in the event of a technical communications error between the client device 108a and the bloom filter 152. Second, the bloom filter 152 accounts for a uniqueness characteristic or attribute according to either a creative ID or IP address in an efficient manner, by counting the bits that are “on” in the bloom filter 152, which correspond to the creative ID, and/or IP address that is either qualified or not by the unique ID, number, or key. Finally, as illustrated by block 512, the method 500 includes one or more operations for determining other counts, for example, unique viewer counts, advertisement frequency counts, or the like, based on data received from the collection plugin 114.

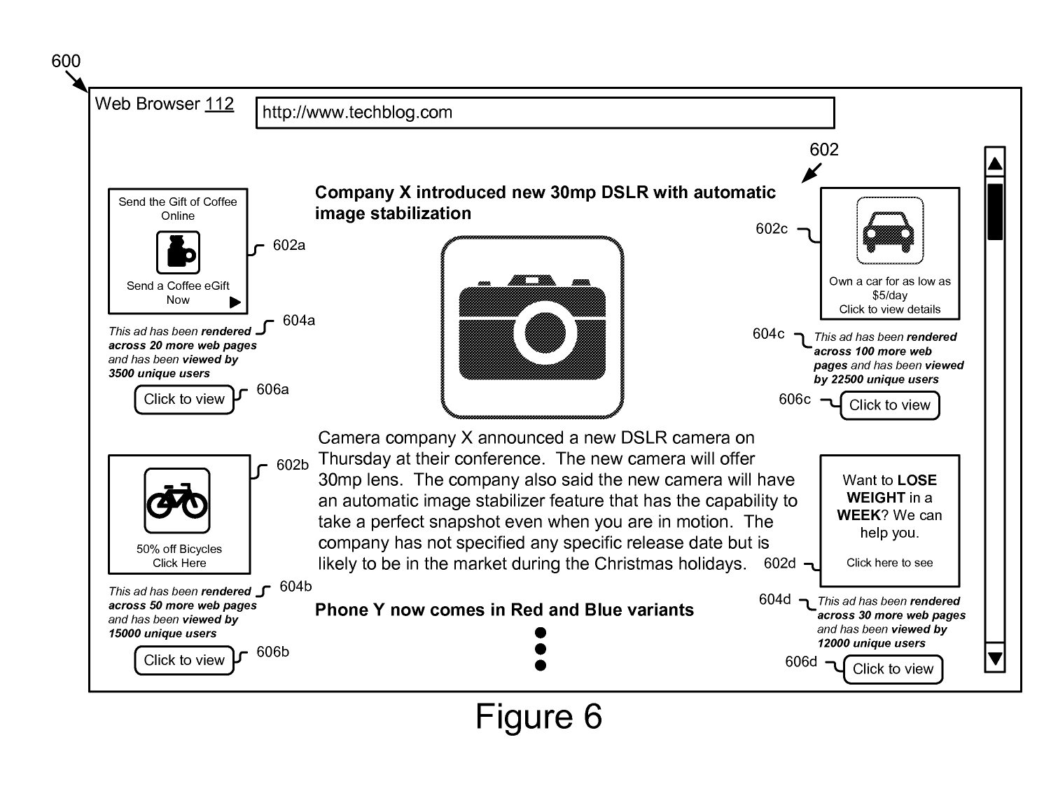

FIG. 6 illustrates a graphical representation of a user interface 600 that may be displayed to a client on the client device 108a (through 108n). The user interface 600 indicates the web browser 112, with illustrations of a plurality of advertisement messages and visual displays indicated generally by reference numeral 602. For example, several advertisements are illustrated. They include those indicated by reference numerals 602a, 602b, 602c, and 602d. The plurality of messages to indicate an accurate count of particular advertisement renderings and viewers are indicated at 604a, 604b, 604c, and 604d. A visual icon or other display button to receive client input to view is indicated at 606a, 606b, 606c, and 606d.

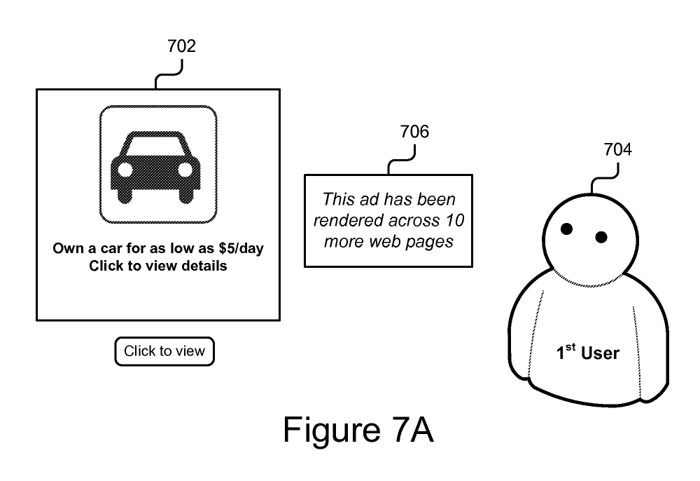

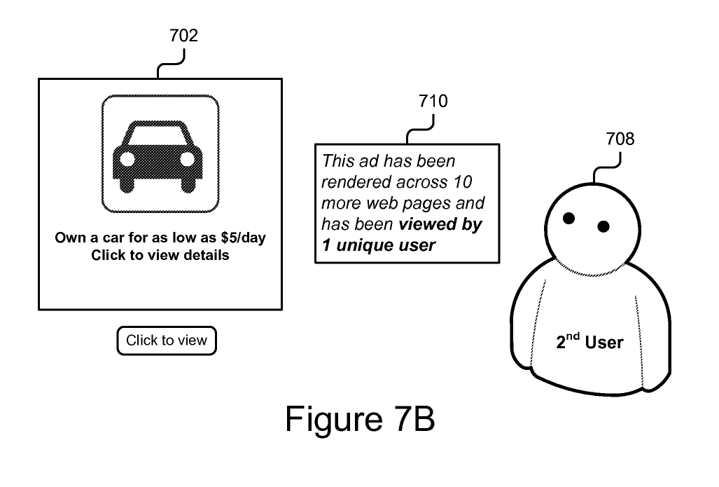

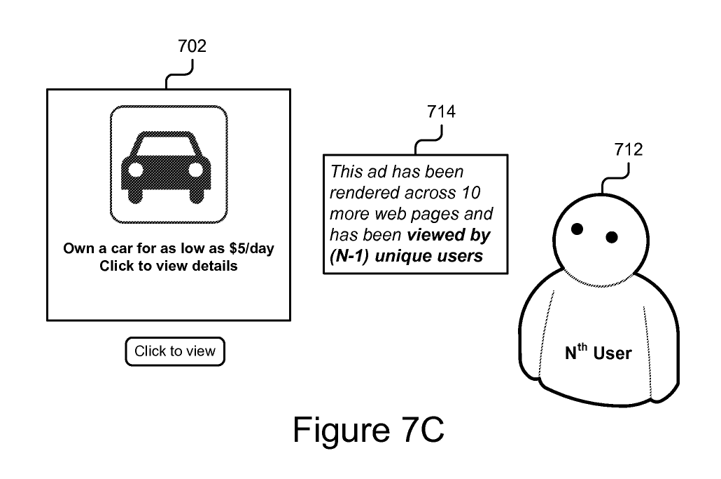

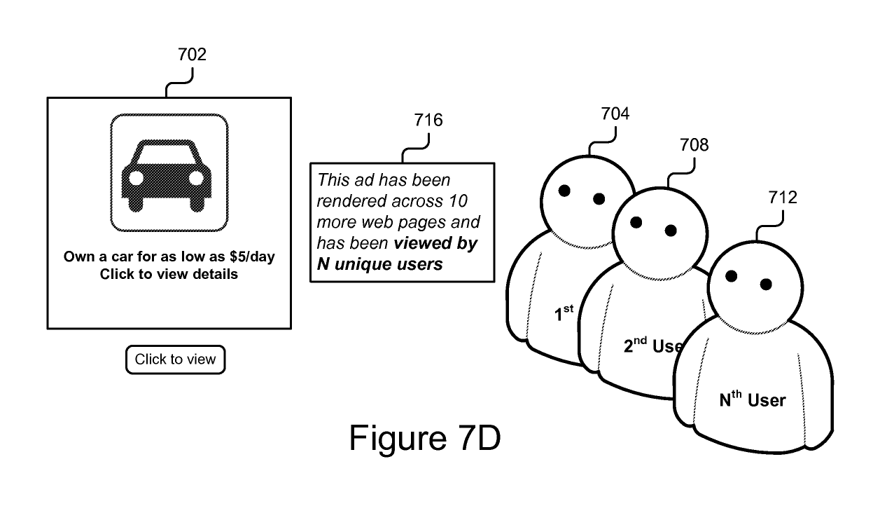

FIG. 7A is a graphical representation illustrating an example scenario with respect to a particular advertisement 702 offering sale of a car that is viewed for the very first time by a first user 704. In this particular instance, there is a message 706 that simply indicates that this particular advertisement has been rendered across ten other web pages.

FIG. 7B is a graphical representation illustrating another example scenario where a second user 708 views the same advertisement 702 referenced in FIG. 7A. The message display 710 here indicates that this particular advertisement has been rendered across ten other web pages and has been viewed by one unique viewer (since it is viewed by the first user 704 as shown in FIG. 7A).

FIG. 7C is a graphical representation illustrating yet another example scenario in which an nth (e.g., 10^{th}) user 712 views the same advertisement 702 referenced in FIG. 1. In this example, as N−1 (i.e. 9) users have already viewed the advertisement 702, in which case the graphical user interface provides a message 714 indicating that this advertisement 702 has been viewed by N−1 unique users.

FIG. 7D is a graphical representation illustrating an example scenario with first -nth users viewing the same advertisement 702 again (i.e., multiple viewings). This example illustrates that the system 100 provides the same advertisement count in instances where users 704, 708, and 712 view advertisement 702 that they have already viewed before. In this instance, the message 716 displayed indicates that the advertisement has been viewed by N unique users.

FIG. 8 illustrates an example data storage configuration 308, with data stored to reflect a unique Ad-Rendering Count, indicated by reference numeral 802, an Ad-Frequency count, indicated by reference numeral 804, Unique-Users Count, indicated by reference numeral 806, Random Numbers 808, and possible other types of data, indicated by reference numeral 810. Example criteria for each of these data types indicated is illustrated beside each count. The Unique-Ad-Rendering Count 802 may be the number of times an Ad has been rendered or loaded across a plurality of web pages. The Ad-Frequency Count 804 may be the number of times a user has seen a particular Ad regardless of the context in which it is viewed. The Unique-Users Count 806 may be the number of unique users who have seen an Ad without regard to how often they see it. For example, IP address and/or user ID associated with a user viewing an Ad may be stored to avoid counting the same user again for the same Ad. The Random Numbers 808 are numbers generated randomly and assigned to each Ad at the client or consumer side, when an Ad impression is served. Other data 810 includes User IDs associated with or assigned to users who have viewed advertisements, unique Ad IDs associated with Ads present on a plurality of web pages, IP addresses to uniquely determine the machines from which a user viewed an Ad, page-load timestamps etc.

It should be recognized that the preceding description of the various embodiments of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the blocks, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the blocks, routines, features, attributes, methodologies and other aspects of the present technology can be implemented as software, hardware, firmware, or any combination of the three. Also, wherever a component, an example of which is illustrated by a block, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

1. A method implemented across a network for determining a count for advertising impressions that have rendered across a universe of webpages accessed over the network by user devices, comprising:
requesting an advertisement, by one or more processors coupled to the network, by a particular webpage from the universe of webpages from an advertisement server to place the advertisement and an associated code including a Javascript tag in that particular webpage;
receiving the advertisement and related code from the advertisement server, by the one or more processors coupled to the network, the ad server adapted to place the advertisement and the Javascript tag on the particular webpage;
facilitating rendering of the advertisement on a browser on a user device, by the one or more processors coupled to the network, the code configured to execute and establish communication by the user device with an analytics server, the analytics server comprising an array of bloom filters, the code writing data on the instance of rendering of the advertisement to the analytics server at various times and for various predetermined reasons;
upon multiple instances of rendering of the advertisement on a particular webpage, the analytics server for each occurrence of data being written, generating unique qualifying data and creating an entry into a first one of the bloom filters, by the one or more processors, the bloom filter referring to the advertisement in that instance and the data being written providing several variables, including a unique user agent, a unique rendering of the advertisement, and a unique IP address plus the unique user agent, the analytics server operating a program that performs a check to determine if a particular condition has occurred, the particular condition formulated to determine if the bloom filter has grown to a size that will cause the bloom filter to yield a predetermined amount of false positive for a particular application;
monitoring a threshold characteristic of the bloom filter in the event that condition occurs, the same program replacing the bloom filter with another from the array when a threshold size is reached to prevent a count of advertisement renderings that does not meet a particular threshold;
maintaining a count for the advertisement and incrementing the count upon considering the unique qualifying data, and the bloom filter configured to account for duplicate viewings by a user of the advertisement and to write a single count for multiple viewings; and
providing a user interface for display to a user to indicate a predetermined count with respect to the advertisement and to indicate unique attributes relating to the advertisement.

2. A computer-implemented method according to claim 1, wherein the advertisement includes one or more advertisements that are displayed on a hosted web page.

3. (canceled)

4. (canceled)

5. The computer-implemented method of claim 1, wherein the threshold characteristic of the bloom filter is a size beyond which the bloom filter yields predetermined results.

6. The computer-implemented method of claim 1, wherein replacing the bloom filter includes creating a new bloom filter.

7. (canceled)

8. (canceled)

9. A computer-program product, comprising a non-transitory computer-useable medium including a computer-readable program, wherein the computer-readable program when executed on a computer causes the computer to:
request an advertisement from an advertisement server;
receive the advertisement and related code from the advertisement server, the advertisement server adapted to place the advertisement and the Javascript tag on the particular webpage;
facilitate rendering of the advertisement on a browser, wherein the code establishes communication with an analytics server, the code writing data on the instance of rendering of the advertisement to the analytics server at various times and for various predetermined reasons;
with every instance of rendering of the advertisement, the analytics server for each occurrence of data being written, creating an entry into a bloom filter from an array of bloom filters in the analytics server of unique qualifying data including a creative advertisement identification including an IP-Address Identifier configured to uniquely identify particular user devices from which users viewed the advertisement on the universe of web pages, the bloom filter referring to the advertisement in that instance and the data being written providing several variables, the analytics server operating a program that performs a check to determine if a particular condition has occurred, the particular condition to determine if the bloom filter has grown to a size that will cause the bloom filter to yield a predetermined amount of false positive for a particular application;
monitor a threshold characteristic of the bloom filter in the event that condition occurs, the same program replacing the bloom filter with another from the array when a threshold size is reached to prevent a particular count of advertisement renderings; and
provide a user interface for display to a user, the user interface indicating a predetermined count with respect to the advertisement and indicating unique attributes relating to the advertisement.

10. A computer-program product according to claim 9, wherein the advertisement includes one or more advertisements that are displayed on a hosted web page.

11. (canceled)

12. (canceled)

13. A computer-program product according to claim 9, wherein the threshold characteristic of the bloom filter is a predetermined size beyond which the bloom filter yields predetermined results that do not meet certain criteria.

14. A computer-program product according to claim 9, wherein replacing the bloom filter includes creating a new bloom filter.

15. A computer-program product according to claim 9, wherein the bloom filter accounts for duplicate viewings by a user of the advertisement and reflects a single count for multiple viewings.

16. A computer-program product according to claim 9, wherein the computer- readable program when executed on a computer further causes the computer to:
provide a user interface for display to a user, wherein the user interface indicates a predetermined count with respect to the advertisement and indicates unique attributes relating to the advertisement.

17. A system implemented across a network having one or more publishing sites associated with at least one web page entity, each publishing site having at least one web page having content that is displayable to any user of the publishing site, the web page having at least one available advertisement space, the system, comprising:
a processor programmed for communication with memory;
an analytics server including an array of bloom filters coupled to the memory; and;
a memory storing instructions that, when executed, cause the system to:
request an advertisement from an advertisement server;
receive the advertisement and related code from the advertisement server;
facilitate rendering of the advertisement on a browser, wherein the code establishes communication with the analytics server and
with every instance of rendering of the advertisement, a particular bloom filter from the array of bloom filters in the analytics server of unique qualifying data including a creative advertisement identification including an IP-Address Identifier configured to uniquely identify particular user devices from which users viewed the advertisement on the universe of web pages, the bloom filter referring to the advertisement in that instance and wherein the data being written provides several variables, the analytics server operating a program that performs a check to determine if a particular condition has occurred, the particular condition to determine if the bloom filter has grown to a size that will cause the bloom filter to yield a predetermined amount of false positive for a particular application; and
monitor a threshold characteristic of the bloom filter in the event that condition occurs, the same program replacing the bloom filter with another from the array when a threshold size is reached to prevent a count of advertisement renderings that does not satisfy particular criteria; and
provide a user interface for display to a user, wherein the user interface indicates a predetermined count with respect to the advertisement and indicates unique attributes relating to the advertisement.

18. A system according to claim 17, wherein the advertisement includes one or more advertisements that are displayed on a hosted web page.

19. (canceled)

20. (canceled)

21. A system according to claim 17, wherein the threshold characteristic of the bloom filter is a size beyond which the bloom filter yields predetermined results that do not meet certain predetermined criteria.

22. A system according to claim 17, wherein replacing the bloom filter includes creating a new bloom filter.

23. A system according to claim 17, wherein the bloom filter accounts for duplicate viewings by a user of the advertisement and reflects a single count for multiple viewings.

24. A system according to claim 17, wherein the memory stores further instructions that cause the system to:
provide a user interface for display to a user, wherein the user interface indicates a predetermined count with respect to the advertisement and indicates unique attributes relating to the advertisement.
